(19) United States
(12) Patent Application Publication
(10) Pub. No.: US 2026/0213909 A1
(43) Pub. Date: Jul. 23, 2026

(54) DEVICE AND METHOD FOR TRAINING RECEIVER IN WIRELESS COMMUNICATION SYSTEM

(71) Applicant: LG ELECTRONICS INC., Seoul (KR)

(72) Inventors: Kyungho LEE, Seoul (KR); Sangrim LEE, Seoul (KR); Yeongjun KIM, Seoul (KR)

(73) Assignee: LG ELECTRONICS INC., Seoul (KR)

(21) Appl. No.: 19/136,767

(22) PCT Filed: Dec. 9, 2022
(86) PCT No.: PCT/KR2022/020042

§ 371 Date: Jun. 6, 2025

(51) Int. Cl. H04L 5/00; H04W 8/24

(52) U.S. Cl. CPC H04L 5/0091; H04L 5/0048; H04W 8/24

(57) ABSTRACT

The present disclosure is to train a transceiver model in a wireless communication system, and an operation method of a user equipment (UE) may comprise the steps of: transmitting capability information to a base station; receiving configuration information related to reference signals from the base station; receiving the reference signals on the basis of the configuration information; and transmitting feedback information corresponding to the reference signals. The configuration information may comprise information related to a receiver model for a reception operation of the UE and information related to at least one kernel function related to the receiver model.

### CROSS-REFERENCE TO RELATED APPLICATION(S)

This application is the National Stage filing under 35 U.S.C. 371 of International Application No. PCT/KR2022/020042, filed on Dec. 9, 2022, the contents of which are all incorporated by reference herein in their entirety.

### TECHNICAL FIELD

The following description relates to a wireless communication system, and more particularly, to an apparatus and method for performing learning for a receiver in a wireless communication system.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure may provide an apparatus and method for effectively performing learning for transmitter and receiver models in a wireless communication system.

The present disclosure may provide an apparatus and method for performing learning for a receiver based on artificial intelligence or machine learning models in a wireless communication system.

The present disclosure may provide an apparatus and method for performing learning for a receiver based on a Gaussian process (GP) model in a wireless communication system.

The present disclosure may provide an apparatus and method for performing active learning for a receiver based on a GP model in a wireless communication system.

The present disclosure may provide an apparatus and method for determining a reference signal pattern for performing online learning for a receiver based on a GP model in a wireless communication system.

The present disclosure may provide an apparatus and method for determining a reference signal pattern for performing active learning for a receiver based on a GP model in a wireless communication system.

The present disclosure may provide an apparatus and method for generating information related to determining a reference signal pattern required for active learning in a wireless communication system.

The present disclosure may provide an apparatus and method for exchanging information required for active learning for a receiver based on a GP model in a wireless communication system.

The present disclosure may provide an apparatus and method for determining uncertainty related to reference signal patterns in a wireless communication system.

The technical objectives of the present disclosure are not limited to the aforementioned aspects, and other technical objectives not explicitly mentioned may be recognized by those skilled in the relevant art from the embodiments of the present disclosure described below.

According to an embodiment of the present disclosure, a method for operating a user equipment (UE) in a wireless communication system, the method may include: transmitting, to a base station, capability information; receiving, from the base station, configuration information related to reference signals; receiving the reference signals based on the configuration information; and transmitting feedback information related to the reference signals, wherein the configuration information includes information related to a receiver model for a reception operation of the UE and information related to at least one kernel function related to the receiver model.

According to an embodiment of the present disclosure, a method for operating a base station in a wireless communication system, the method may include: receiving, from a user equipment (UE), capability information; transmitting configuration information related to reference signals; transmitting the reference signals based on the configuration information; and receiving, from the UE, feedback information related to the reference signals, wherein the configuration information includes information related to a receiver model for a reception operation of the UE and information related to at least one kernel function related to the receiver model.

According to an embodiment of the present disclosure, a user equipment (UE) in a wireless communication system, the UE may include: a transceiver; and a processor connected to the transceiver, wherein the processor is configured to perform operations may include: transmitting, to a base station, capability information; receiving, from the base station, configuration information related to reference signals; receiving the reference signals based on the configuration information; and transmitting feedback information related to the reference signals, wherein the configuration information includes information related to a receiver model for a reception operation of the UE and information related to at least one kernel function related to the receiver model.

According to an embodiment of the present disclosure, a base station in a wireless communication system, the base station may include: a transceiver; and a processor connected to the transceiver, wherein the processor is configured to perform operations may include: receiving, from a user equipment (UE), capability information; transmitting configuration information related to reference signals; transmitting the reference signals based on the configuration information; and receiving, from the UE, feedback information related to the reference signals, wherein the configuration information includes information related to a receiver model for a reception operation of the UE and information related to at least one kernel function related to the receiver model.

According to an embodiment of the present disclosure, a communication device may include: at least one processor; a processor connected to the transceiver, at least one computer memory connected to the at least one processor and storing instructions that, based on being executed by the at least one processor, cause the device to perform operations, wherein the operations may include: transmitting, to a base station, capability information; receiving, from the base station, configuration information related to reference signals; receiving the reference signals based on the configuration information; and transmitting feedback information related to the reference signals, wherein the configuration information includes information related to a receiver model for a reception operation of the UE and information related to at least one kernel function related to the receiver model.

According to an embodiment of the present disclosure, a non-transitory computer-readable medium storing at least one instruction, comprising the at least one instruction being executable by a processor, wherein the at least one instruction is configured to perform operations may include: transmitting, to a base station, capability information; receiving, from the base station, configuration information related to reference signals; receiving the reference signals based on the configuration information; and transmitting feedback information related to the reference signals, wherein the configuration information includes information related to a receiver model for a reception operation of the UE and information related to at least one kernel function related to the receiver model.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, a receiver based on artificial intelligence or machine learning models may be effectively learned.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows another example of a wireless device applicable to the present disclosure.

FIG. 4 shows an example of a hand-held device applicable to the present disclosure.

FIG. 5 shows an example of a car or an autonomous driving car applicable to the present disclosure.

FIG. 6 shows an example of artificial intelligence (AI) device applicable to the present disclosure.

FIG. 7 shows a method of processing a transmitted signal applicable to the present disclosure.

FIG. 8 shows an example of a communication structure providable in a 6th generation (6G) system applicable to the present disclosure.

FIG. 9 shows an electromagnetic spectrum applicable to the present disclosure.

FIG. 10 shows a THz communication method applicable to the present disclosure.

FIG. 11 shows a perceptron architecture in an artificial neural network applicable to the present disclosure.

FIG. 12 shows an artificial neural network architecture applicable to the present disclosure.

FIG. 13 shows a deep neural network applicable to the present disclosure.

FIG. 14 shows a convolutional neural network applicable to the present disclosure.

FIG. 15 shows a filter operation of a convolutional neural network applicable to the present disclosure.

FIG. 16 shows a neural network architecture with a recurrent loop applicable to the present disclosure.

FIG. 17 shows an operational structure of a recurrent neural network applicable to the present disclosure.

FIG. 18 shows sampling schemes for active learning, based on an embodiment of the present disclosure.

FIGS. 19a to 19c show examples of active learning and passive learning results, based on an embodiment of the present disclosure.

FIG. 20 shows functional structures of devices supporting active learning, based on an embodiment of the present disclosure.

FIG. 21 shows an example of a procedure for performing learning for a transmitter model or a receiver model, based on an embodiment of the present disclosure.

FIG. 22 shows an example of a procedure for supporting learning of a transmitter model or receiver model, based on an embodiment of the present disclosure.

FIG. 23 shows an example procedure for providing capability information related to active learning, based on an embodiment of the present disclosure.

FIG. 24 shows an example procedure for configuring information related to active learning, based on an embodiment of the present disclosure.

FIG. 25 shows an example of a procedure for performing active learning, based on an embodiment of the present disclosure.

FIG. 26 shows an example of operational timing for active reference signal transmission and channel estimation, based on an embodiment of the present disclosure.

FIG. 27 shows an example procedure for reporting results of active learning, based on an embodiment of the present disclosure.

FIG. 28 shows an example procedure for terminating active learning, based on an embodiment of the present disclosure.

FIG. 29 shows examples of reference signal patterns for active learning, based on an embodiment of the present disclosure.

FIGS. 30a and 30b show examples of evaluation results of uncertainty for a GP model, based on an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

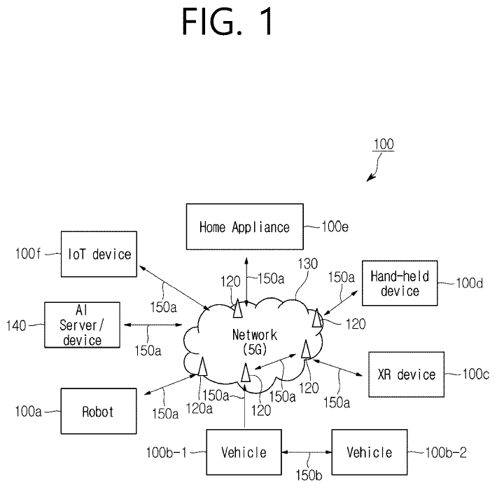

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

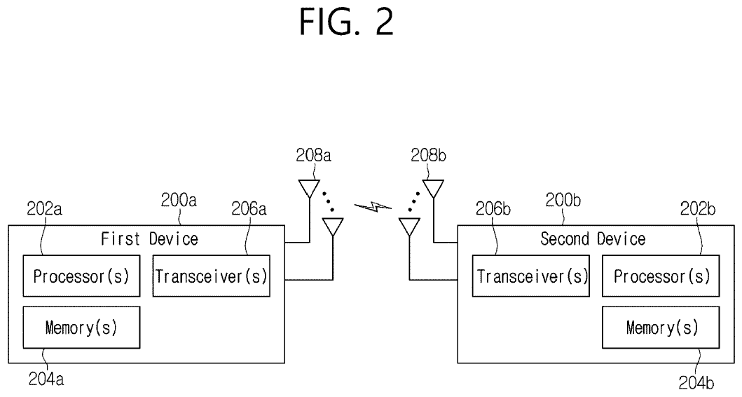

FIG. 2 shows an example of a wireless device applicable to the present disclosure.

Referring to FIG. 2, a first wireless device 200a and a second wireless device 200b may transmit and receive radio signals through various radio access technologies (e.g., LTE or NR). Here, (the first wireless device 200a, the second wireless device 200b) may correspond to (the wireless device 100x, the base station 120) and/or (the wireless device 100x, the wireless device 100x) of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

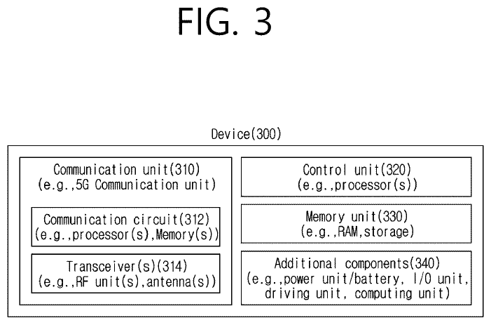

FIG. 3 shows another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

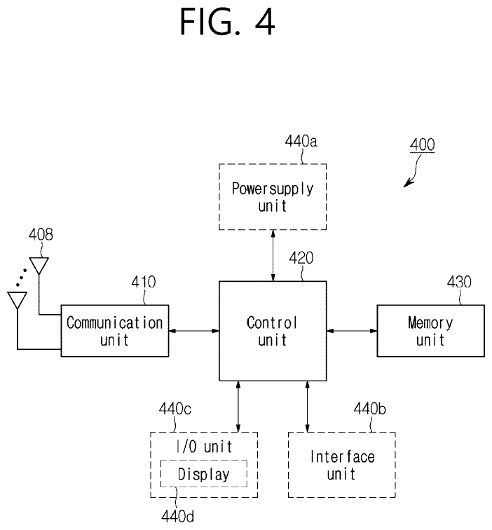

FIG. 4 shows an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

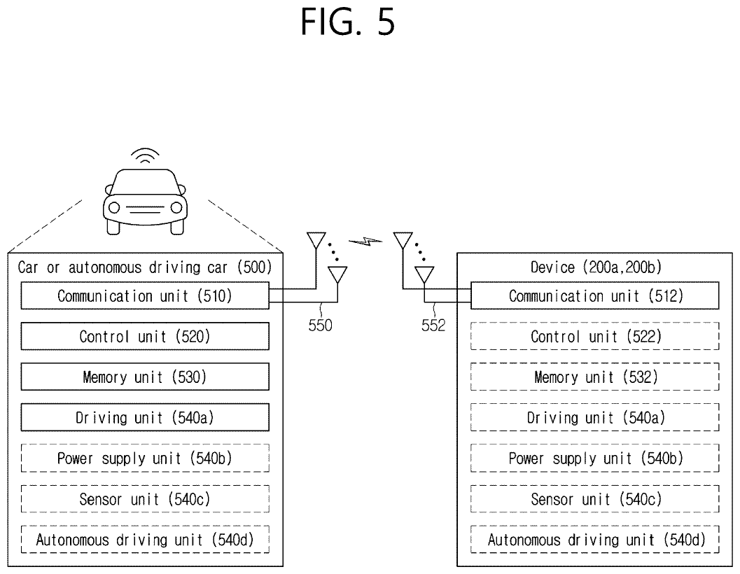

FIG. 5 shows an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

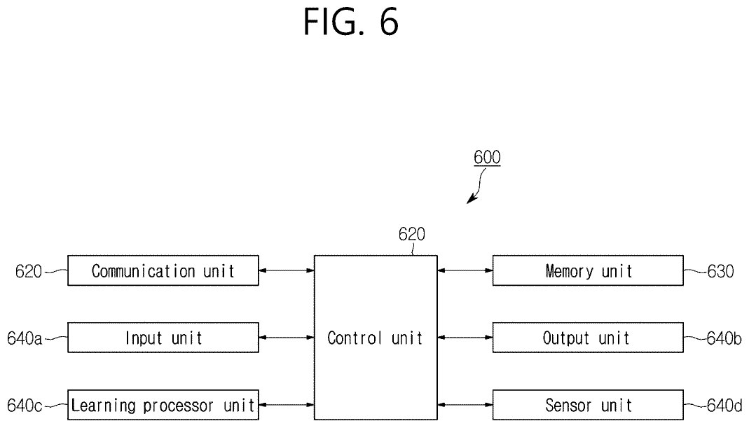

FIG. 6 shows an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640a/640b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 630.

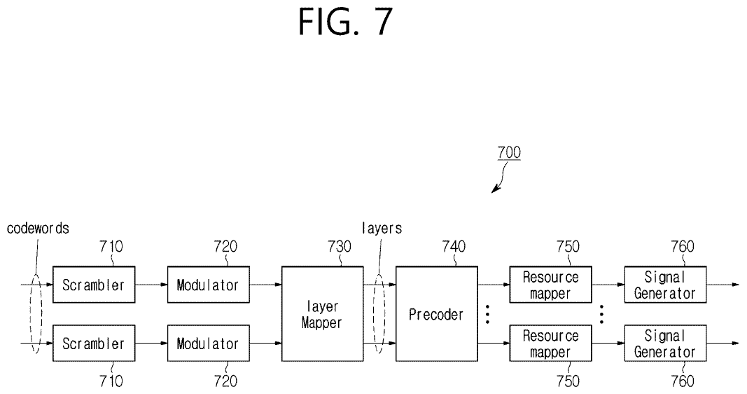

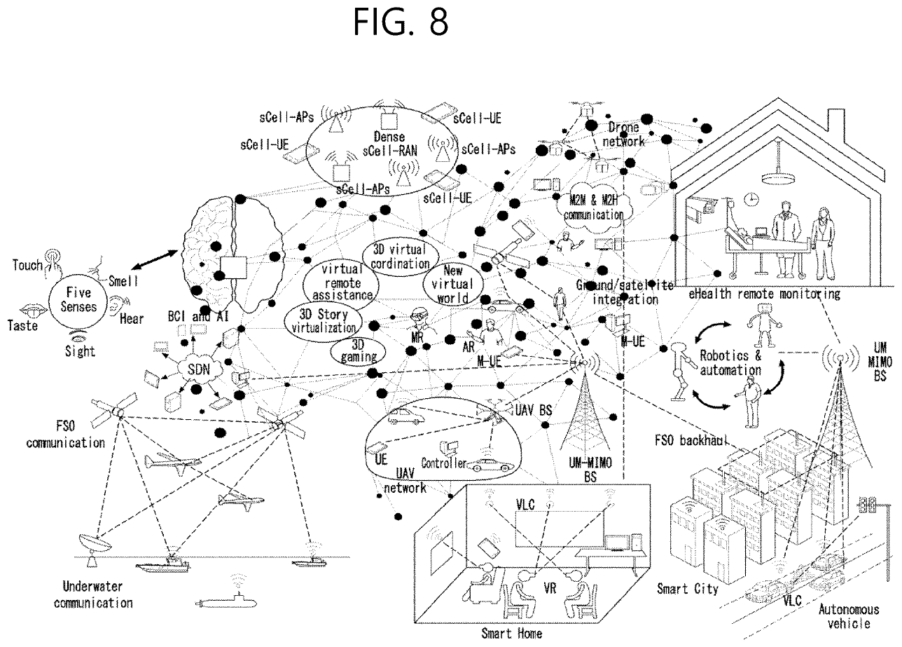

FIG. 7 shows a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | |
|---|---|
| Per device peak data rate | 1 Tbps |
| E2E latency | 1 ms |
| Maximum spectral efficiency | 100 bps/Hz |
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

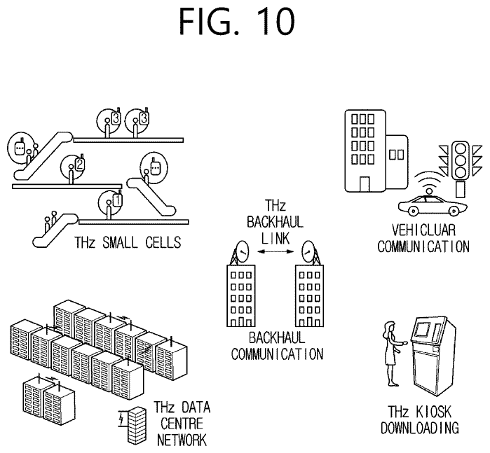

FIG. 10 shows an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel measurement and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Terahertz (THz) Communication

THz communication is applicable to the 6G system. For example, a data rate may increase by increasing bandwidth. This may be performed by using sub-THz communication with wide bandwidth and applying advanced massive MIMO technology.

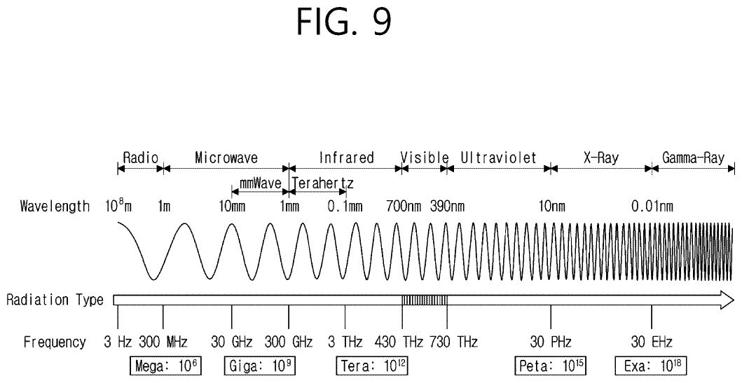

FIG. 9 shows an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 shows a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Artificial Intelligence System

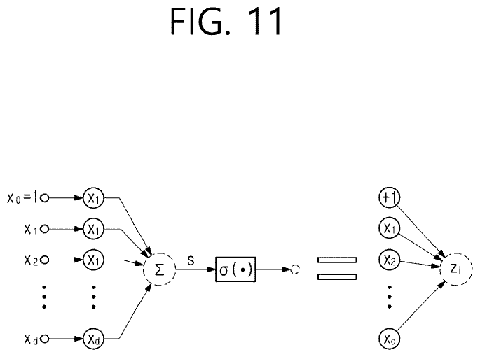

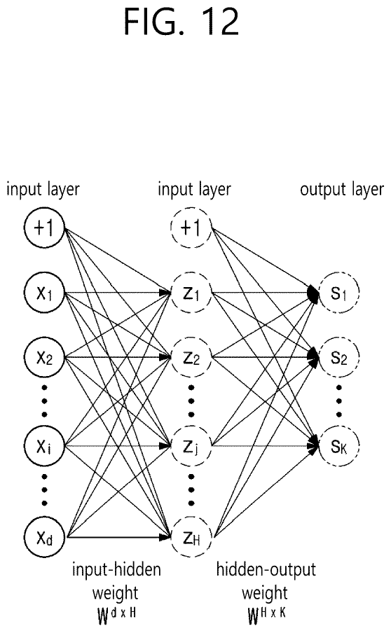

FIG. 11 shows a perceptron architecture in an artificial neural network applicable to the present disclosure. In addition, FIG. 12 shows an artificial neural network architecture applicable to the present disclosure.

As described above, an artificial intelligence system may be applied to a 6G system. Herein, as an example, the artificial intelligence system may operate based on a learning model corresponding to the human brain, as described above. Herein, a paradigm of machine learning, which uses a neural network architecture with high complexity like artificial neural network, may be referred to as deep learning. In addition, neural network cores, which are used as a learning scheme, are mainly a deep neural network (DNN), a convolutional deep neural network (CNN), and a recurrent neural network (RNN). Herein, as an example referring to FIG. 11, an artificial neural network may consist of a plurality of perceptrons. Herein, when an input vector x={x₁, x₂, . . . , x_{d}} is input, each component is multiplied by a weight {W₁, W₂, . . . , Wd}, results are all added up, and then an activation function (.) is applied, of which the overall process may be referred to as a perceptron. For a large artificial neural network architecture, when expanding the simplified perceptron structure illustrated in FIG. 11, an input may be applied to different multidimensional perceptrons. For convenience of explanation, an input value or an output value will be referred to as a node.

Meanwhile, the perceptron structure shown in FIG. 11 may be described to consist of a total of 3 layers based on an input value and an output value. An artificial neural network, which has H (d+1)-dimensional perceptrons between the 1^{st} layer and the 2^{nd} layer and K (H+1)-dimensional perceptrons between the 2^{nd} layer and the 3^{rd} layer, may be expressed as in FIG. 12.

Herein, a layer, in which an input vector is located, is referred to as an input layer, a layer, in which a final output value is located, is referred to as an output layer, and all the layers between the input layer and the output layer are referred to as hidden layers. As an example, 3 layers are disclosed in FIG. 12, but since an input layer is excluding in counting the number of actual artificial neural network layers, it can be understood that the artificial neural network shown in FIG. 12 has a total of 2 layers. An artificial neural network is constructed by connecting perceptrons of a basic block two-dimensionally.

The above-described input layer, hidden layer and output layer are commonly applicable not only to multilayer perceptrons but also to various artificial neural network architectures like CNN and RNN, which will be described below. As there are more hidden layers, an artificial neural network becomes deeper, and a machine learning paradigm using a sufficiently deep artificial neural network as a learning model may be referred to as deep learning. In addition, an artificial neural network used for deep learning may be referred to as a deep neural network (DNN).

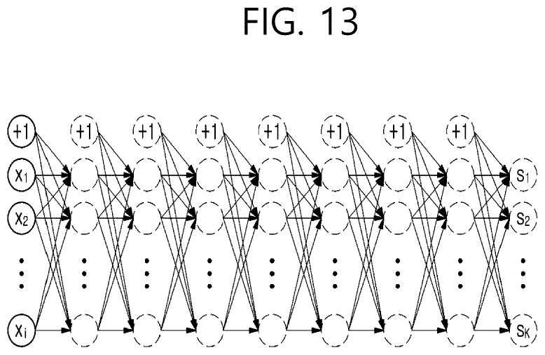

FIG. 13 shows a deep neural network applicable to the present disclosure.

Referring to FIG. 13, a deep neural network may be a multilayer perceptron consisting of 8 layers (hidden layers+output layer). Herein, the multilayer perceptron structure may be expressed as a fully-connected neural network. In a fully-connected neural network, there may be no connection between nodes in a same layer and only nodes located in neighboring layers may be connected with each other. A DNN has a fully-connected neural network structure combining a plurality of hidden layers and activation functions so that it may be effectively applied for identifying a correlation characteristic between an input and an output. Herein, the correlation characteristic may mean a joint probability between the input and the output.

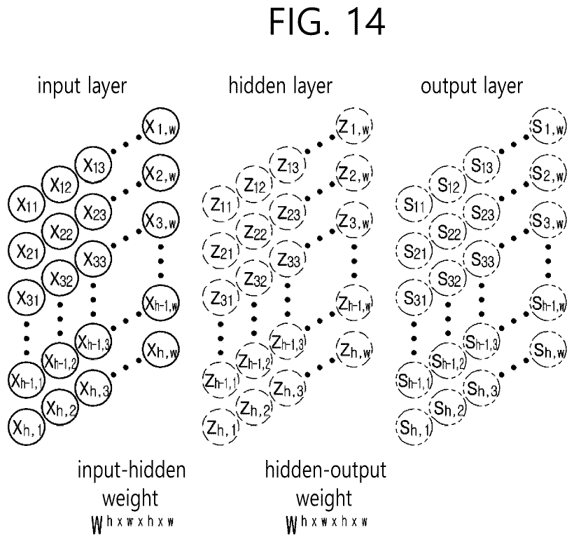

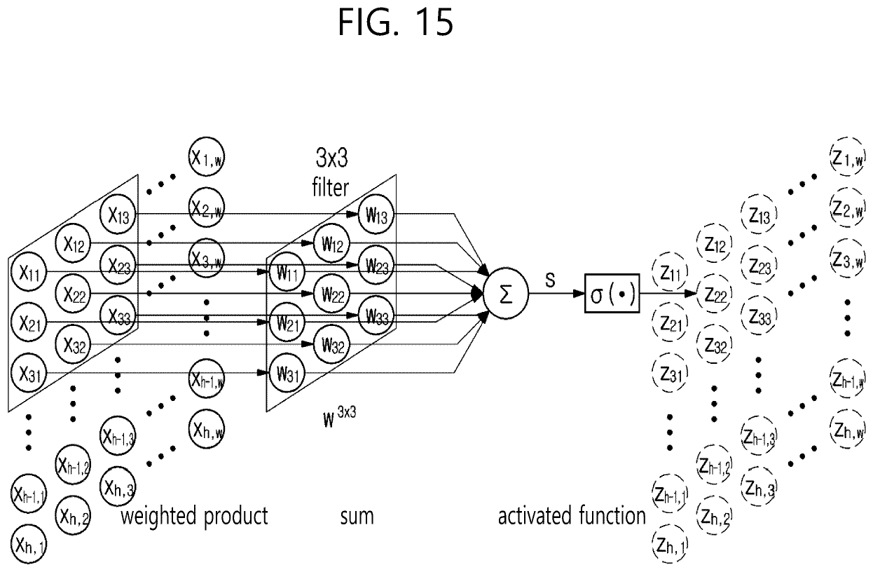

FIG. 14 shows a convolutional neural network applicable to the present disclosure. In addition, FIG. 15 shows a filter operation of a convolutional neural network applicable to the present disclosure.

As an example, depending on how to connect a plurality of perceptrons, it is possible to form various artificial neural network structures different from the above-described DNN. Herein, in the DNN, nodes located in a single layer are arranged in a one-dimensional vertical direction. However, referring to FIG. 14, it is possible to assume a two-dimensional array of w horizontal nodes and h vertical nodes (the convolutional neural network structures of FIG. 14). In this case, since a weight is applied to each connection in a process of connecting one input node to a hidden layer, a total of h×w weights should be considered. As there are h×w nodes in an input layer, a total of h²w² weights may be needed between two neighboring layers.

Furthermore, as the convolutional neural network of FIG. 14 has the problem of exponential increase in the number of weights according to the number of connections, the presence of a small filter may be assumed instead of considering every mode of connections between neighboring layers. As an example, as shown in FIG. 15, weighted summation and activation function operation may be enabled for a portion overlapped by a filter.

At this time, one filter has a weight corresponding to a number as large as its size, and learning of a weight may be performed to extract and output a specific feature on an image as a factor. In FIG. 15, a 3×3 filter may be applied to a top rightmost 3×3 area of an input layer, and an output value, which is a result of the weighted summation and activation function operation for a corresponding node, may be stored at z₂₂.

Herein, as the above-described filter scans the input layer while moving at a predetermined interval horizontally and vertically, a corresponding output value may be put a position of a current filter. Since a computation method is similar to a convolution computation for an image in the field of computer vision, such a structure of deep neural network may be referred to as a convolutional neural network (CNN), and a hidden layer created as a result of convolution computation may be referred to as a convolutional layer. In addition, a neural network with a plurality of convolutional layers may be referred to as a deep convolutional neural network (DCNN).

In addition, at a node in which a current filter is located in a convolutional layer, a weighted sum is calculated by including only a node in an area covered by the filter and thus the number of weights may be reduced. Accordingly, one filter may be so used as to focus on a feature of a local area. Thus, a CNN may be effectively applied to image data processing for which a physical distance in a two-dimensional area is a crucial criterion of determination. Meanwhile, a CNN may apply a plurality of filters immediately before a convolutional layer and create a plurality of output results through a convolution computation of each filter.

Meanwhile, depending on data properties, there may be data of which a sequence feature is important. A recurrent neural network structure may be a structure obtained by applying a scheme, in which elements in a data sequence are input one by one at each timestep by considering the distance variability and order of such sequence datasets and an output vector (hidden vector) output at a specific timestep is input with a very next element in the sequence, to an artificial neural network.

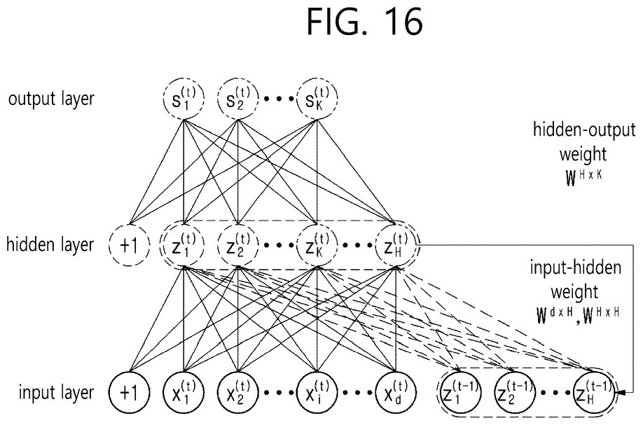

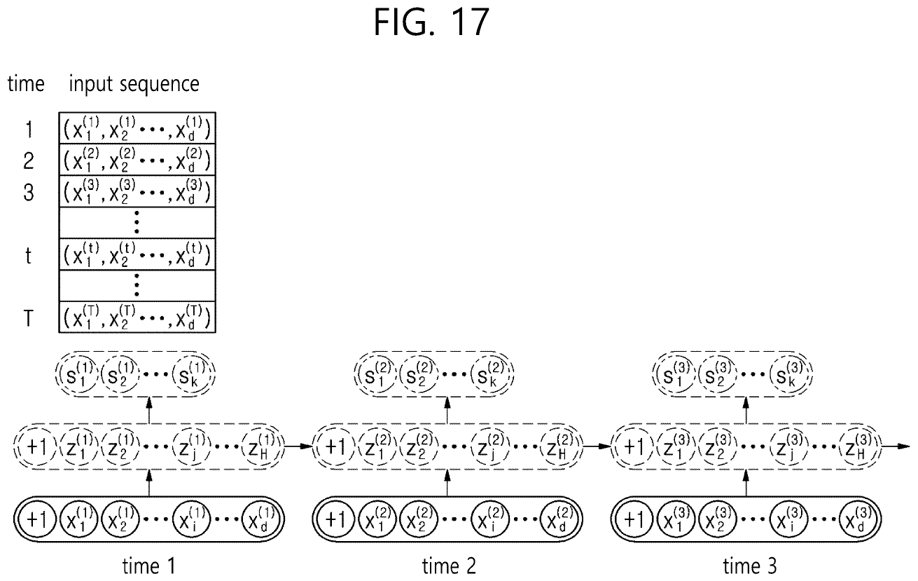

FIG. 16 shows a neural network architecture with a recurrent loop applicable to the present disclosure. FIG. 17 shows an operational structure of a recurrent neural network applicable to the present disclosure.

Referring to FIG. 16, a recurrent neural network (RNN) may have a structure which applies a weighted sum and an activation function by inputting hidden vectors {z₁^{(t-1)}, z₂^{(t-1)}, . . . , z_{H}^{(t-1)}} of an immediately previous timestep t−1 during a process of inputting elements {x₁^{(t)}, x₂^{(t)}, . . . , x_{d}^{(t)}} of a timestep t in a data sequence into a fully connected neural network. The reason why such hidden vectors are forwarded to a next timestep is because information in input vectors at previous timesteps is considered to have been accumulated in a hidden vector of a current timestep.

In addition, referring to FIG. 17, a recurrent neural network may operate in a predetermined timestep order for an input data sequence. Herein, as a hidden vector {z₁⁽¹⁾, z₂⁽¹⁾, . . . , z_{H}⁽¹⁾} at a time of inputting an input vector {x₁^{(t)}, x₂^{(t)}, . . . , x_{d}^{(t)}} of timestep 1 into a recurrent neural network is input together with an input vector {x₁⁽²⁾, x₂⁽²⁾, . . . , x_{d}⁽²⁾} of timestep 2, a vector {z₁⁽²⁾, z₂⁽²⁾, . . . , z_{H}⁽²⁾} of a hidden layer is determined through a weighted sum and an activation function. Such a process is iteratively performed at timestep 2, timestep 3 and until timestep T.

Meanwhile, when a plurality of hidden layers are allocated in a recurrent neural network, this is referred to as a deep recurrent neural network (DRNN). A recurrent neural network is so designed as to effectively apply to sequence data (e.g., natural language processing).

Apart from DNN, CNN and RNN, other neural network cores used as a learning scheme include various deep learning techniques like restricted Boltzmann machine (RBM), deep belief networks (DBN) and deep Q-Network, and these may be applied to such areas as computer vision, voice recognition, natural language processing, and voice/signal processing.

Recently, there are attempts to integrate AI with a wireless communication system, but these are concentrated in an application layer and a network layer and, especially in the case of deep learning, in a wireless resource management and allocation filed. Nevertheless, such a study gradually evolves to a MAC layer and a physical layer, and there are attempts to combine deep learning and wireless transmission especially in a physical layer. As for a fundamental signal processing and communication mechanism, AI-based physical layer transmission means application of a signal processing and communication mechanism based on an AI driver, instead of a traditional communication framework. For example, it may include deep learning-based channel coding and decoding, deep learning-based signal estimation and detection, deep learning-based MIMO mechanism, and AI-based resource scheduling and allocation.

### Detailed Embodiments of the Present Disclosure

The present disclosure relates to a technique for applying active learning to perform training for transmitter and receiver models in a wireless communication system. Hereinafter, the present disclosure describes various embodiments for supporting and performing active learning for AI or machine learning model-based transmitters and receivers.

The present disclosure addresses an online learning problem using reference signals in a wireless communication system that delivers end-to-end messages using transmitter and receiver models configured with AI or machine learning models. In an embodiment, the AI or machine learning model may be a Gaussian process (GP) model. A wireless communication system based on a GP model utilizes the property of approximating arbitrary or nonlinear functions effectively using nonlinear kernel basis functions. Here, the kernel basis function, also referred to as a ‘kernel function,’ may be specified by the type of kernel function and values of hyperparameters that constitute the kernel function. In a scenario where a message is output from a transmitter model, passes through a wireless channel, and is received by a receiver model, excellent transmission and reception performance may be achieved by properly utilizing the above-described properties. However, to achieve good performance, training of AI or machine learning models during actual operation is required. Increasing the complexity of the model used in the UE may cover complex wireless channels entirely, but increased complexity may act as an implementation burden. The model used in the UE may be designed with appropriate complexity. For example, when the UE moves, the channel environment continuously changes over time, increasing the probability that the UE's AI or machine learning model does not sufficiently reflect channel characteristics. Therefore, online learning is required.

In general training techniques, when AI or machine learning models obtain training data, samples are randomly selected from the channel data distribution. In this case, because the current parameter situation of the model is not sufficiently considered, either a large amount of training data may be required, or performance accuracy may be reduced. This may lead to significant consumption of radio resources to transmit many reference signals during online training. To resolve problems such as performance degradation and high consumption of radio resources, a training procedure is required for transmitter and/or receiver models that efficiently utilize reference signal resources by considering the state of the model.

Thus, the present disclosure proposes applying active learning technology. Active learning is a learning technique that evaluates data distribution and the uncertainty and diversity of the model interpreting the data distribution, then samples data based on the evaluation results. In particular, the present disclosure aims to address the problem of disagreement occurring between devices during uncertainty and diversity evaluation as an issue in the active learning process. For example, the present disclosure proposes online learning technology for communication systems using active learning to facilitate easy learning of various channel propagation environments, such as below 6 GHz communication, mm Wave, and THz communication.

Active learning is a type of machine learning technique that performs labeling of data for learning based on interaction with the user. Conversely, passive learning may be understood as supervised learning that utilizes already labeled training data.

$$( x , y ) ∈ D ∼ p ( D ) \qquad [ Equation 1 ]$$

In [Equation 1], x refers to data, y refers to a label, D refers to a dataset, and p(D) refers to the distribution of the dataset.

In passive learning, labeling y for data x may be provided, and samples (x, y) from the training dataset D following distribution p(D) may all be provided in advance. In active learning, during training, data x is efficiently sampled from distribution p(D), a user is queried for labeling y, and training proceeds based on the training data to which the queried labeling has been provided. Here, labeling tasks in active learning are referred to as ‘annotation.’ In active learning, if data x is given, the entity providing information related to label y may be referred to as a ‘user,’ an ‘oracle,’ or an ‘annotator.’

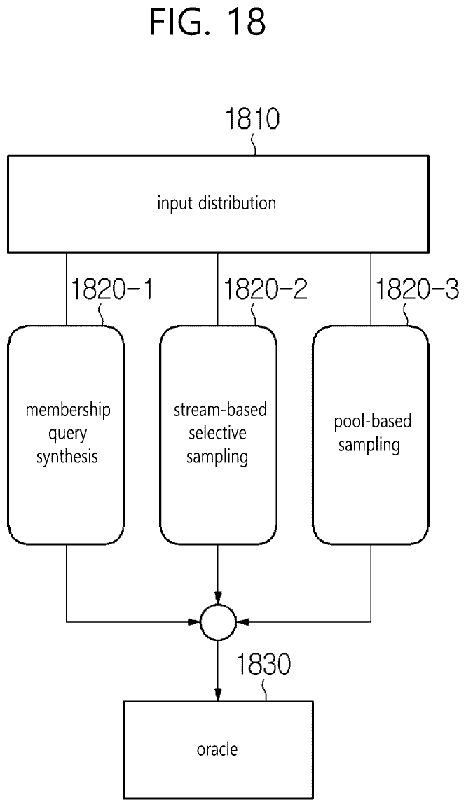

FIG. 18 shows sampling schemes for active learning, based on an embodiment of the present disclosure. FIG. 18 shows three representative active learning schemes. The three schemes are related to operations of sampling data x from an input distribution (1810). Here, the input distribution (1810) may be referred to as an instance space. In the membership query synthesis scheme (1820-1), a model synthesizes sample x from the input distribution (1810) for training and requests labeling y for sample x from an oracle. For example, the model synthesizes sample x and queries the oracle (1830). Stream-based selective sampling (1820-2) selectively distinguishes data x continuously extracted from the input distribution (1810) and requests labeling y from the oracle (1830) for the distinguished data x. Pool-based sampling (1820-3) includes all data x obtained from the input distribution (1810) into a pool, selects the most beneficial sample for learning from the pool, and requests labeling y from the oracle (1830) for the selected sample. In this way, by the model actively participating in the data collection process, the number of samples required for training may be reduced, and performance may also be improved.

For example, active learning may be used to reduce the cost of obtaining training data. In data-driven machine learning, obtaining data requires significant costs. To save these high costs, active learning may improve learning capability even with fewer data samples. Moreover, active learning may enhance the speed and performance of learning.

Active sampling in active learning may be divided largely into two types: uncertainty sampling and diversity sampling. Uncertainty sampling is a method of enhancing effectiveness by first learning the most ambiguous data during training. Diversity sampling is a method of quickly learning the overall distribution by uniformly sampling representative data from the entire data distribution.

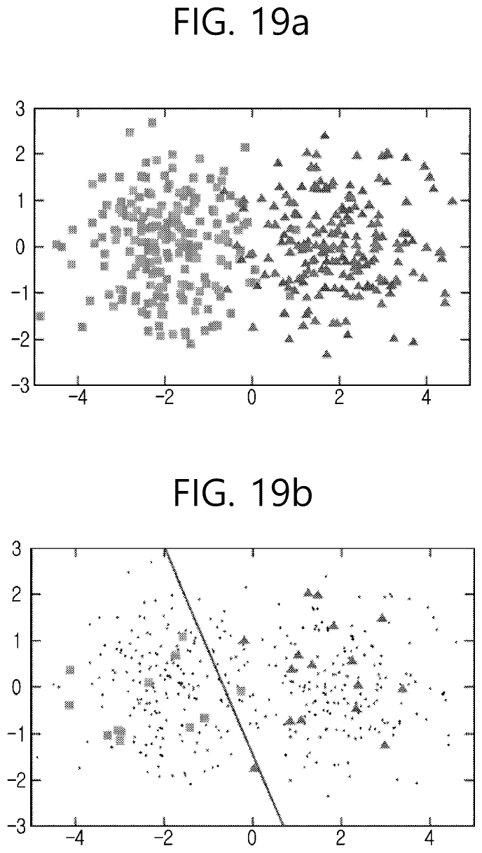

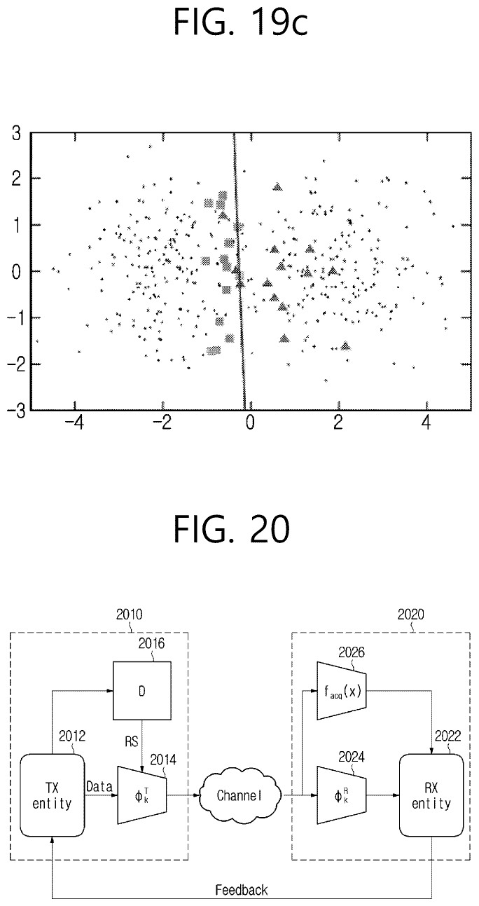

Uncertainty sampling used in active learning is a scheme that enhances effectiveness by preferentially learning the most ambiguous data during training. The effectiveness of uncertainty sampling may be observed in a simple binary classification task, examples of which are shown in FIGS. 19a to 19c. FIGS. 19a to 19c show examples of active learning and passive learning results, based on an embodiment of the present disclosure. FIG. 19a shows the overall distribution of sampled data. As shown in FIG. 19a, learning begins in a state where all data are acquired through pool-based learning. FIG. 19b shows an example result of passive learning. Since random sampling is performed, input values are selected evenly across the entire distribution, causing the boundary to be learned inaccurately. FIG. 19c shows an active learning result where sampling is concentrated on regions near the boundary with high uncertainty. Referring to FIG. 19c, it may be confirmed that favorable results are achieved even with a small number of samples. Active learning may be applied not only to classification tasks exemplified in FIGS. 19a to 19c, but also to regression tasks.

The effectiveness of active learning with uncertainty sampling has been theoretically proven for some analytically solvable cases. Compared to passive learning, active learning is known to reduce the number of samples required for training to a logarithmic complexity level. Assuming an ideal case and considering a simple binary classifier, it may be easily expected that applying binary search-based active learning sampling instead of exhaustive search achieves complexity reduction to a logarithmic level. As a more specific example, considering a learning problem for data uniformly sampled from a unit sphere in d-dimensional space, in the case of a homogeneous linear separator, passive learning has a sample complexity of O(d/ε), whereas query-by-committee active learning, which decides based on results from multiple models, may receive data with complexity O((d/ε)*log(1/ε)), and then label and learn data with complexity O(d*log(1/ε)). Here, ε refers to the error performance of the learning model.

In this disclosure, to evaluate the uncertainty of the model samples, a Bayesian model capable of quantifying the uncertainty may be used. At this point, the model parameter φ which is the target of uncertainty evaluation for the transceiver model, refers to a random variable rather than a deterministic value. The training of the Bayesian model aims to find the posterior probability of the data as shown in [Equation 2].

$$p ( ϕ \vert {D}_{t r a i n} ) = \frac{p ( y \vert x , ϕ ) p ( ϕ )}{\int p ( y \vert x , ϕ ) p ( {ϕ}^{′} ) d {ϕ}^{′}} \qquad [ Equation 2 ]$$

In [Equation 2], φ refers to the model parameter, D refers to the training data set, p(φ|D) refers to the prior distribution of the model parameter including prior information related to the model, x refers to the data, y refers to the output of the model, p(y|x, φ) refers to the probability of y given x and φ, and p(φ) refers to the prior distribution of φ. In [Equation 2], the denominator refers to the probability of the training data, referred to as evidence, and is equal to p(D).

The predictive probability distribution p(y′|x′,D) for new data x′ may be computed as follows by marginalizing over the conditional model probability and the posterior probability of φ.

$$p ( {y}^{′} \vert {x}^{′} , D ) = \int p ( {y}^{′} \vert {x}^{′} , ϕ ) p ( ϕ \vert D ) d ϕ \qquad [ Equation 3 ]$$

In [Equation 3], y′ refers to the output of the new model, x′ refers to the new data, D refers to the training data set, and p(y′|x′,D) refers to the predictive probability distribution for the new data x′.

Once the predictive probability distribution is obtained, the mean and variance may be determined using that distribution. Since the model parameter φ refers to a random variable, the model's uncertainty is reflected. Additionally, by utilizing [Equation 3], the variance of the prediction may be determined. The variance may be used for uncertainty evaluation.

During training, except for linear models, a closed-form derivation of the posterior probability of φ is extremely difficult, and various methods have been proposed to address this. In particular, approximate methods and sampling-based approaches may be applied to obtain the posterior probability.

In this case, the acquisition function for estimating uncertainty may also be obtained by applying Bayesian assumptions. For example, the acquisition function may be obtained by reflecting the model's prior distribution over multiple possible acquisition functions and then integrating. In this case, the acquisition function f_acq(x) refers to a functional that includes the Bayesian predictive distribution p(y|x,θ). As in the example of [Equation 4] below, the acquisition function may be a functional that marginalizes the prior distribution over functions. For example, Shannon entropy may be used. In this case, uncertainty may be evaluated based on the maximum entropy criterion of the model's estimated value for the given reference signal.

$$H ( y \vert x , {D}_{t r a i n} ) = - \sum p ( y = k \vert x , {D}_{t r a i n} ) log p ( y = k \vert x , {D}_{train} ) \qquad [ Equation 4 ]$$

In [Equation 4], y refers to the model output, x refers to the model input, D_train refers to the training data, and H(y|x,D_train) refers to the entropy of y given x and D_train.

According to an embodiment, as shown in [Equation 5] below, uncertainty may be evaluated based on the mutual information between the model's prediction and the model φ.

$$I ( y , \vert x , ϕ , {D}_{t r a i n} ) = H ( y \vert x , {D}_{t r a i n} ) - {E}_{p ( ϕ \vert {D}_{t r a i n} )} \{ H ( y \vert x , ϕ ) \} \qquad [ Equation 5 ]$$

In [Equation 5], y refers to the model output, x refers to the model input, φ refers to the model parameter, D_train refers to the training data, I(y|x,φ,D_train) refers to the mutual information given the model input, H(y|x,D_train) refers to the entropy of y conditioned on x and D_train, and E_(p(φ|D_train)) {H(y|x,θ)} refers to the average entropy with respect to the posterior distribution of φ.

According to an embodiment, as shown in [Equation 6] below, uncertainty may be evaluated based on the variance ratio of the model output.

$${variation}_{ratio} = 1 - max p ( y \vert x , {D}_{train} ) \qquad [ Equation 6 ]$$

In [Equation 6], variation_ratio refers to the variation ratio, y refers to the model output, x refers to the model input, D_train refers to the training data, and max p(y|x,D_train) refers to the maximum of the conditional probability of the output variable given the input variable x.

If online learning is performed based on data in a communication system, it is necessary to resolve issues related to active learning. In communication, sampling and labeling may be defined as transmissions between a transmitter and a receiver. When transmitting reference signals between transmitter and receiver, it is desirable to minimize wireless resource usage in tasks estimating the channel using the reference signals.

In a Gaussian process, for any infinite collection of points x_1, x_2, x_3, . . . , the joint probability distribution p(f(x_1), f(x_2), f(x_3), . . . ) of the function f(x) is defined as a Gaussian distribution. A Gaussian process may be completely specified by a mean and covariance. In this disclosure, the channel estimation problem aims to be solved as a regression problem via a Gaussian process. In [Equation 7] below, h(x) is a channel estimation regression function for point x and is a Gaussian process.

$$y = h ( x ) + n \qquad [ Equation 7 ]$$

In [Equation 7], h(x) refers to a channel estimation regression function for point x, and n refers to the received noise with variance σ_n\hat{ }2.

h(x) is a Gaussian process with mean and covariance as in [Equation 8].

$$m ( x ) = 𝔼 [ h ( x ) ] \qquad [ Equation 8 ]$$

$$κ ( x , {x}^{′} ) = 𝔼 [ ( h ( x ) - m ( x ) ( h ( {x}^{′} ) - m ( {x}^{′} ) ]$$

In [Equation 8], m(x) refers to the mean of h(x), h(x) refers to the channel estimation regression function for point x, and κ(x,x′) refers to the covariance between points x and x′.

The covariance κ(x,x′) may be expressed using any one of a plurality of kernel functions.

$$κ ( x , {x}^{′} ) = exp ( - \frac{{‖ x - {x}^{′} ‖}^{2}}{2 {ϕ}_{l}^{2}} ) \qquad [ Equation 9 ]$$

In [Equation 9], κ(x,x′) refers to the covariance between points x and x′, and φ_1\hat{ }2 refers to a model parameter that determines the statistical similarity between samples of the Gaussian process.

The Ornstein-Uhlenbeck kernel may be given as shown in [Equation 10] below.

$$κ ( x , {x}^{′} ) = exp ( - \frac{‖ x - {x}^{′} ‖}{{ϕ}_{ι}} ) \qquad [ Equation 10 ]$$

In [Equation 10], κ(x,x′) refers to the covariance between points x and x′, and φ_1 refers to a model parameter that determines the statistical similarity between samples of the Gaussian process.

The rational quadratic kernel may be given as shown in [Equation 11] below.

$$κ ( x , {x}^{′} ) = {( 1 + {‖ x - {x}^{′} ‖}^{2} )}^{α} \qquad [ Equation 11 ]$$

In [Equation 11], κ(x,x′) refers to the covariance between points x and x′.

The most commonly used kernel function is given as follows in [Equation 12].

$$κ ( x , {x}^{′} ) = {ϕ}_{1} exp ( - {\sum }_{m}^{M} \frac{{‖ x - {x}^{′} ‖}^{2}}{2 {ϕ}_{2}^{2}} ) + {ϕ}_{3} \qquad [ Equation 12 ]$$

In [Equation 12], κ(x,x′) refers to the covariance, and σ_i refers to the model parameter.

FIG. 20 shows functional structures of devices supporting active learning, based on an embodiment of the present disclosure. FIG. 20 shows a transmission/reception model in a scenario where, according to an embodiment, a first device (2010) among two communicating devices (2010, 2020) functions as a transmitter, and a second device (2020) functions as a receiver. In downlink communication, the first device (2010) may be understood as a base station, and the second device (2020) may be understood as a UE. In uplink communication, the first device (2010) may be understood as a UE, and the second device (2020) may be understood as a base station. The transmission/reception model of FIG. 20 includes transmitter model parameters φ_k\hat{ }T and receiver model parameters φ_k\hat{ }R for an element k of an active learning reference signal set at a specific time. Here, k refers to an index representing one among K types of operated reference signals.

Referring to FIG. 20, the first device (2010) includes a transmit entity (2012), a transmitter model (2014), and a reference signal generation unit (2016). The transmit entity (2012) performs overall control and processing for data transmission. For example, the transmit entity (2012) may generate transmission data and interpret feedback information received from the second device (2020). The transmitter model (2014) is an artificial intelligence or machine learning model (e.g., GP model)-implemented data processing block. The transmitter model (2014) generates a signal including at least one of data and a reference signal. The reference signal generation unit (2016) generates and provides reference signals based on one type or pattern among the active learning reference signal set D [symbol] (x,y).

The second device (2020) includes a receive entity (2022), a receiver model (2024), and an evaluation unit (2026). The receive entity (2022) performs overall control and processing for data reception. For example, the receive entity (2022) may generate feedback information to be provided to the first device (2010). For example, the feedback information may include at least one of preferred active RS, active learning parameters, and information related to loss. The receiver model (2024) is an artificial intelligence or machine learning model (e.g., GP model)-implemented data processing block. The receiver model (2024) may reconstruct data from a data signal received from the first device (2010) and perform measurements related to reference signals. The evaluation unit (2026) evaluates signals received from the first device (2010). The evaluation result may include information representing uncertainty used for uncertainty sampling.

In the active learning reference signal set D [symbol] (x,y), p(D), the independent variable vector x is generated based on at least one or a combination of frequency, time, antenna, and context information of devices (2010, 2020), and corresponds to patterns of reference signals allocated to wireless resources. The patterns of reference signals may be interpreted in various ways. For example, a pattern may represent the distribution of reference signals within a given resource area or indicate each unit resource (e.g., RE) within the resource area. Here, context information may include a UE's position, acceleration, velocity, and posture information affecting channel data sampling. y refers to a received signal. The reference signal set for active learning determines wireless resource efficiency based on the density of patterns corresponding to the independent variable x.

In FIG. 20, φ_k\hat{ }T refers to a parameter of the transmitter model applied to the transmitter model (2014). It performs a type of precoding for the active learning reference signal k and data transmission signals. φ_k\hat{ }R refers to a parameter of the receiver model applied to the receiver model (2024). The receiver knows the active learning reference signal k transmitted by the transmitter. Since the transmitter and receiver kernels include the model's prior distribution, the transmitter and receiver kernels are Bayesian models. The regression function h(x) refers to a Gaussian process, and in regression, its values provide a probability distribution while also incorporating the model's uncertainty. The selection of the prior distribution depends on the operation of the network and channel context.

The training of the function h_φ(x), which is included as a model parameter in both the transmitter and receiver, may be determined through numerical analysis based on the gradient of the marginal log-likelihood as in [Equation 13] for the data set D={x∈X,y∈Y} given a reference signal.

$$\frac{\partial }{\partial {ϕ}_{i}} log p ( y \vert X ) = \frac{1}{2} {y}^{T} {K}^{- 1} \frac{\partial K}{\partial {ϕ}_{i}} {K}^{- 1} y - \frac{1}{2} t r ( {K}^{- 1} \frac{\partial K}{\partial {ϕ}_{i}} ) \qquad [ Equation 13 ]$$

In this context, K refers to the sum of the covariance and variance for the training data and background noise.

The estimation h_* for X_* at a location where a reference signal is not present may be performed via the following predictive Gaussian probability distribution together with the data set D={x∈X,y∈Y}.

$$p ( {h}_{*} \vert D , {X}_{*} ) = N ( {m}_{*} , {\sum }_{*} ) \qquad [ Equation 14 ]$$

$${m}_{*} = 𝔼 [ {h}_{*} \vert D , {X}_{*} ] = {K ( {X}_{*} , X ) [ K ( X , X ) + {σ}_{n}^{2} I ]}^{- 1} y$$

$${\sum }_{*} = K ( {X}_{*} , {X}_{*} ) - {K ( {X}_{*} , X ) [ K ( X , X ) + {σ}_{n}^{2} I ]}^{- 1} K ( X , {X}_{*} )$$

Here, K refers to the covariance function of the Gaussian process for the input points. The predictive distribution is determined as a function of the covariance function and the noise variance.

f_acq(x) refers to an acquisition function of an artificial intelligence or machine learning model (e.g., GP model) that evaluates uncertainty. f_acq(x) evaluates reference signals passed through the current channel based on the transmitter and receiver models. Based on the evaluation, the sample location x\hat{ }* most beneficial for active learning may be determined. f_acq(x) may include both the transmitter model φ_k\hat{ }T and the receiver model φ_k\hat{ }R. Therefore, although f_acq(x) is located at the second device (2020) in FIG. 20, the first device (2010) may also include f_acq(x). Similar to training transmitters and receivers, the acquisition values may be alternately determined either by fixing φ_k\hat{ }T and determining the acquisition value contributed by φ_k\hat{ }R, or by fixing φ_k\hat{ }R and determining the acquisition value contributed by φ_k\hat{ }T. Specifically, if determining the acquisition value contributed by φ_k\hat{ }T, the first device (2010) may receive feedback on the acquisition value contributed by φ_k\hat{ }R from the second device (2020) using the active learning configuration values.

For f_acq(x,φ), two uncertainties may be selected. The first is f_acq(x)=σ(x), which is the variance in the Bayesian distribution for x. The second is the expected improvement. The expected improvement may be defined as in [Equation 15] below.

$${f}_{a c q} ( x ) = ( m ( x ) - h ( {x}_{*} ) ) ψ ( \frac{m ( x ) - h ( {x}^{+} )}{σ ( x )} ) + σ ( x ) ζ ( \frac{m ( x ) - h ( {x}^{+} )}{σ ( x )} ) \qquad [ Equation 15 ]$$

In [Equation 15], f_acq(x) refers to the acquisition function, x\hat{ }+refers to the point having the maximum value among the currently observed training samples, m(x) refers to the mean of the Gaussian process, σ(x) is the variance of the Gaussian process, w (x) refers to the cumulative distribution function, and ζ(x) is the standard Gaussian distribution function.

The variance at candidate reference signal location x, enabling the reduction of reference signal resources and enhancement of performance through active learning that gradually selects locations with maximum sample variance. For example, f_acq(x,φ) may represent the maximum prediction error of individual models. For example, f_acq(x,θ) may be used to determine the location x\hat{ }* with the greatest disagreement among individual models. Through this, based on results of f_acq(x,φ), the second device (2020) may request the first device (2010) to use a reference signal pattern with minimal wireless resource consumption from the transmitter and receiver model perspectives.

Since online learning is performed, models φ_k\hat{ }T and φ_k\hat{ }R are updated over time. Additionally, since the contents of models φ_k\hat{ }T and φ_k\hat{ }R are reflected in f_acq(x), f_acq(x) may also be updated.

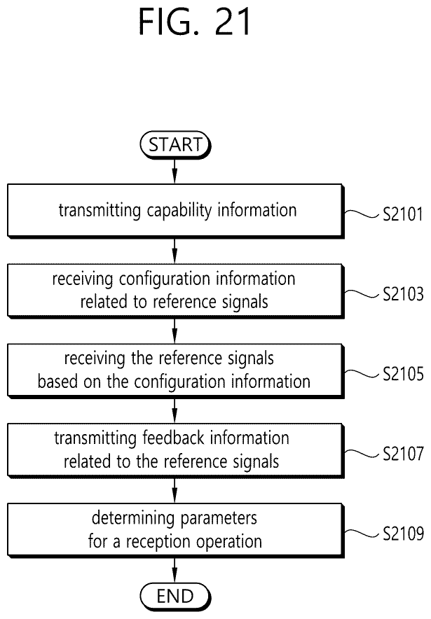

FIG. 21 shows an example of a procedure for performing learning for a transmitter model or a receiver model, based on an embodiment of the present disclosure. FIG. 21 shows an operating method of a UE, and the shown operations may be understood as operations of a receiver (e.g., the second device (2020) of FIG. 20).

Referring to FIG. 21, in step S2101, the UE transmits capability information. For example, the UE transmits a message including capability information. The capability information may include information related to capabilities associated with communication of the UE. Based on an embodiment, the capability information may include information related to active learning. For example, information related to active learning may include at least one of information representing at least one supported artificial intelligence or machine learning model (e.g., GP model) (e.g., identifier, parameter information), information representing at least one supported kernel function, and information representing at least one supported acquisition function. Although not shown in FIG. 21, before transmitting capability information, the UE may receive a message requesting capability information from a base station.

In step S2103, the UE receives configuration information related to reference signals. The UE receives a message including configuration information related to reference signals transmitted by the base station. The configuration information may include at least one of information related to resources allocated for reference signals, information related to operations required in response to receiving the reference signals, and information related to items requiring measurement or feedback. Based on an embodiment, the configuration information may include a request to perform active learning, information related to patterns of reference signals (e.g., identifier information), information related to artificial intelligence or machine learning models for active learning (e.g., identifiers, parameter information of GP models), information related to kernel functions (e.g., types, hyperparameters), information related to an acquisition function for uncertainty evaluation (e.g., type), and a request for feedback representing preferred reference signal patterns.

In step S2105, the UE receives reference signals based on the configuration information. The UE receives the reference signals via resources represented by the configuration information. Here, the reference signals may have at least one pattern. Based on an embodiment, the pattern may represent a distribution of reference signals belonging to a set, indicating at least one of a number of reference signals, a density of reference signals, frequency-axis intervals of reference signals, time-axis intervals of reference signals, and positions of REs (resource elements) allocated for reference signals. According to an embodiment, the pattern may represent one of the REs to which the reference signal may be mapped. According to an embodiment, the pattern may be a configuration for the reference signal, representing at least one of transmission power, sequence, covering code, and slot period during which reference signals are transmitted. For example, at least one pattern applied to the reference signals received in this step may include one of pre-agreed patterns or at least one pattern specified by the UE.

In step S2107, the UE transmits feedback information related to the reference signals. The UE may transmit the feedback information after processing the reference signals. The feedback information may include at least one of measurement results related to the reference signals and a request for subsequent transmission of reference signals. Based on an embodiment, the UE may perform prediction operations for the reference signals using a receiver model, and may determine an uncertainty metric for the prediction results. Here, the uncertainty metric may be determined per reference signal pattern. The UE may determine at least one preferred reference signal pattern based on the uncertainty metric and may transmit feedback information including information related to the at least one preferred reference signal pattern. In addition, feedback information may include a loss value determined based on a measurement result of reference signals, wherein the loss is based on an error between prediction results and labels (e.g., transmitted values of the reference signals).

In step S2109, the UE determines at least one parameter for a reception operation. For example, the UE performs training of a receiver model. Based on an embodiment, the UE may perform training of the receiver model using the reference signals received in step S2105. Additionally, the UE may perform training of the receiver model using additionally received reference signals. Here, the additionally received reference signals may have at least one reference signal pattern requested by the feedback information. Specifically, the UE may determine loss values of prediction results for the reference signals, and may update weights of the receiver model by performing a back-propagation operation based on the loss values. Here, the loss function for determining loss values may vary based on the learning method for the artificial intelligence or machine learning model (e.g., GP model).

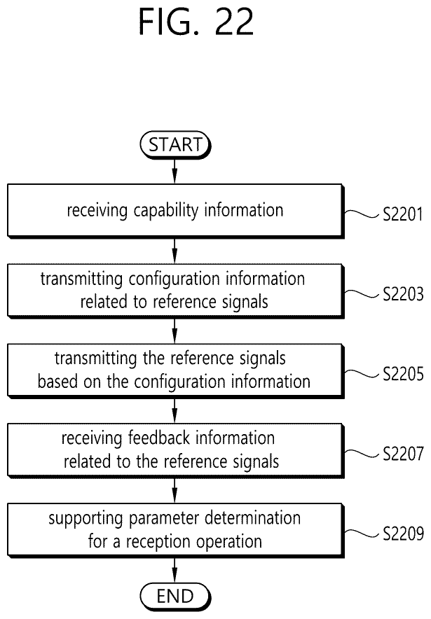

FIG. 22 shows an example of a procedure for supporting learning of a transmitter model or receiver model, based on an embodiment of the present disclosure. FIG. 22 shows an operating method of a base station, and the shown operations may be understood as operations of a transmitter (e.g., the first device (2010) of FIG. 20).

Referring to FIG. 22, in step S2201, the base station receives capability information. For example, the base station receives a message including capability information of the UE. The capability information may include information related to capabilities associated with the communication of the UE. Based on an embodiment, the capability information may include information related to active learning. For example, information related to active learning may include at least one of information representing at least one supported artificial intelligence or machine learning model (e.g., GP model) (e.g., identifier, parameter information), information representing at least one supported kernel function, and information representing at least one supported acquisition function. Although not shown in FIG. 22, before receiving capability information, the base station may receive a message requesting capability information from the UE.

In step S2203, the base station transmits configuration information related to reference signals. The base station transmits a message including configuration information related to subsequently transmitted reference signals. The configuration information may include at least one of information related to resources allocated for reference signals, information related to operations required in response to receiving the reference signals, and information related to items requiring measurement or feedback. Based on an embodiment, the configuration information may include a request to perform active learning, information related to patterns of reference signals (e.g., identifier information), information related to artificial intelligence or machine learning models for active learning (e.g., identifiers, parameter information of GP models), information related to kernel functions (e.g., types, hyperparameters), information related to an acquisition function for uncertainty evaluation (e.g., type), and a request for feedback representing preferred reference signal patterns.

In step S2205, the base station transmits reference signals based on the configuration information. The base station transmits reference signals via resources represented by the configuration information. Here, the reference signals may have at least one pattern. Based on an embodiment, the pattern may represent a distribution of reference signals belonging to a set, indicating at least one of a number of reference signals, a density of reference signals, frequency-axis intervals of reference signals, time-axis intervals of reference signals, and positions of REs (resource elements) allocated for reference signals. According to an embodiment, the pattern may represent one of the REs to which the reference signal may be mapped. According to an embodiment, the pattern may be a configuration for the reference signal, representing at least one of transmission power, sequence, covering code, and slot period during which reference signals are transmitted. For example, at least one pattern applied to the reference signals transmitted in this step may include one of pre-agreed patterns or at least one pattern specified by the UE.

In step S2207, the base station receives feedback information related to the reference signals. The feedback information may include at least one of measurement results related to the reference signals and a request for subsequent transmission of reference signals. Based on an embodiment, the feedback information may include information related to at least one preferred reference signal pattern selected by the UE. In addition, the feedback information may include, as a measurement result for the reference signals, a loss value of prediction results at the UE or a value derived from the loss value. For example, the feedback information may include gradient information of the loss value related to input data to the receiver model of the UE.

In step S2209, the base station supports determination of at least one parameter for a reception operation. For example, the base station supports training of the receiver model at the UE. Based on an embodiment, the base station may transmit reference signals for training the receiver model at the UE. Here, the transmitted reference signals may have at least one reference signal pattern requested by the feedback information.

Based on the embodiments described with reference to FIGS. 21 and 22, training of the receiver model may be performed. Additionally, training of the transmitter model used by the base station may also be performed. Based on an embodiment, the UE may transmit information related to loss values of prediction results to the base station, and the base station may perform training of the transmitter model based on the received information. Alternatively, according to an embodiment, the UE may perform training of the transmitter model and then transmit information related to weights updated through training to the base station.

The embodiments described with reference to FIGS. 21 and 22 may be performed for training transceiver models for downlink communication. If an transceiver model for uplink communication is used, the transceiver model for uplink communication may also be trained using a similar procedure. In this case, since the base station has the receiver model and the UE has the transmitter model, the base station may request a preferred reference signal pattern from the UE, the UE may transmit uplink reference signals, and the base station may perform training of the receiver model.

Hereinafter, more specific embodiments for performing and/or supporting learning for the transmitter model and/or receiver model are described. In the following description, the artificial intelligence or machine learning model is exemplified by a GP model.

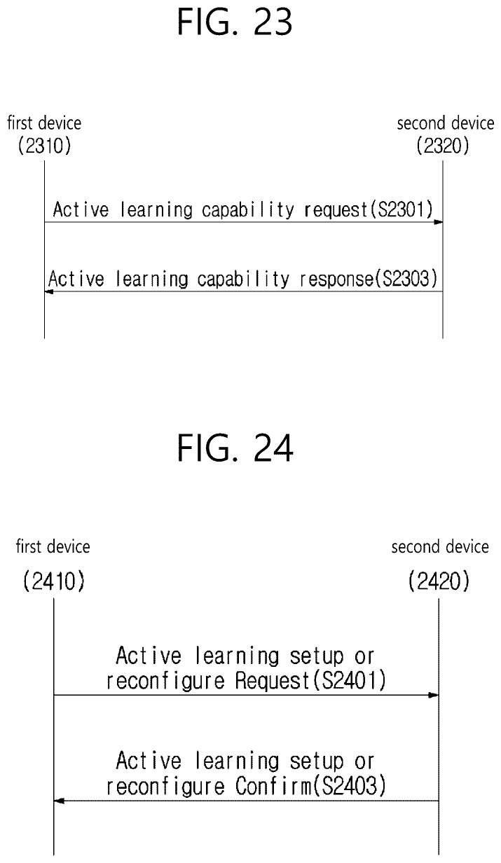

FIG. 23 shows an example procedure for providing capability information related to active learning, based on an embodiment of the present disclosure. FIG. 23 shows signaling for mutual support of initial active learning between a first device (2310) and a second device (2320).

Referring to FIG. 23, in step S2301, the first device (2310) transmits an active learning capability request message to the second device (2320). The active learning capability request message may be transmitted during or after the registration procedure, after the second device (2320) accesses the first device (2310). Here, the active learning capability request message may be referred to as a capability enquiry message.

In step S2303, the second device (2320) transmits an active learning capability response message to the first device (2310). The active learning capability response message includes information related to capabilities supported by the second device (2320) for active learning. For example, the active learning capability response message may include GP model information, including a set of identifiers (IDs) related to supported GP models. For example, the active learning capability response message may include information related to supported kernel functions. For example, the active learning capability response message may include information related to supported acquisition functions. The active learning capability response message may be referred to as a capability information message. In this case, the active learning capability response message may further include various capability information in addition to active learning.

As described with reference to FIG. 23, capability information related to active learning of the second device (2320) may be provided. In addition, capability information related to active learning of the first device (2310) may also be provided to the second device (2320) through the active learning capability request message. In this case, based on an embodiment, the active learning capability response message may include capability information within a range commonly supported by the first device (2310) and the second device (2320). Thus, information elements (IEs) or parameters included in the active learning capability request message and active learning capability response message may include at least one of the items listed in [Table 2] below.

TABLE 2

| Information element | Description |
|---|---|
| Gaussian process model | Set of IDs related to supported |
| | Gaussian models. |
| ernel functions | Set of supported kernel functions. |
| cquisition function | Set of supported acquisition functions. |

FIG. 24 shows an example procedure for configuring information related to active learning, based on an embodiment of the present disclosure. FIG. 24 shows signaling for configuring information related to active learning between a first device (2410) and a second device (2420).

Referring to FIG. 24, in step S2401, the first device (2410) transmits an active learning setup request message to the second device (2420). Here, the active learning setup request message may be referred to as an active learning reconfigure request message. The first device (2410) may control the second device (2420) to handle the related channel task by delivering a pre-trained GP model and associated model parameters related to a channel context. Alternatively, if the transmitter of the first device (2410) does not have a pre-trained model related to the channel context, the first device (2410) may control the second device (2420) to perform the channel task using at least one currently available model.

In step S2403, the second device (2420) transmits an active learning setup confirm message to the first device (2410). Here, the active learning setup confirm message may be referred to as an active learning reconfigure confirm message. For example, the second device transmits a response indicating acceptance of the active learning procedure. For example, the second device (2420) transmits a response indicating that it has obtained information included in the active learning setup request message or has completed configuration based on information included in the active learning setup request message. Subsequently, for online learning, procedures for transmitting and receiving active learning reference signals may be performed.

As described with reference to FIG. 24, information required for the second device (2420) to perform active learning may be provided. Specifically, information elements or parameters included in the active learning setup request message and the active learning setup confirm message may include at least one of the items listed in [Table 3] below.

TABLE 3

| Information element | Description |
|---|---|
| Gaussian process | GP model or related identifier for |
| | active learning. |
| set of RS ID and associated | Identifier (ID) related to the |
| RS patterns | active learning reference signal |
| | pattern set D [symbol] (xi, yi). D is a plurality |
| | of pattern sets of reference signals |
| | with differing densities, or related |
| | identifiers. |
| Model parameters | Parameters related to the GP model. |
| Model parameters | Kernel function types and hyperparameters. |
| Acquisition function | Type of acquisition function. |

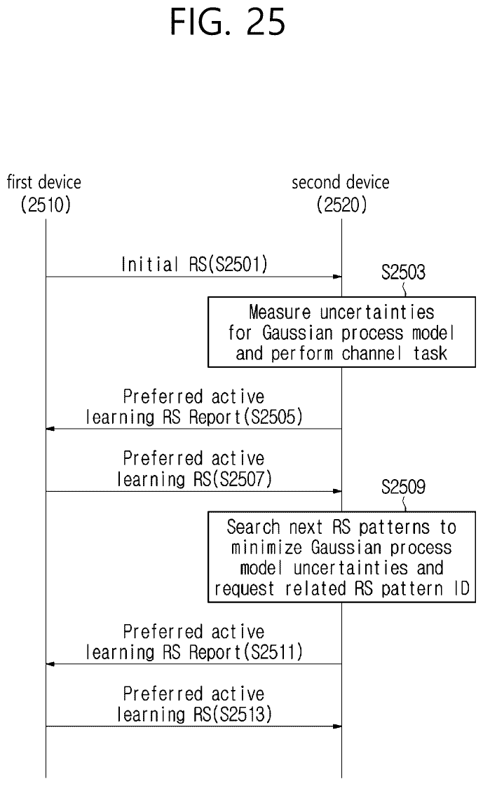

FIG. 25 shows an example of a procedure for performing active learning, based on an embodiment of the present disclosure. FIG. 25 shows signaling for performing active learning between a first device (2510) and a second device (2520).

Referring to FIG. 25, in step S2501, the first device (2510) transmits initial reference signals to the second device (2520). The initial reference signals may include reference signals based on a selected pattern among a set of predefined reference signal patterns for active learning. Here, the first device (2510) may transmit reference signals based on information delivered through the active learning setup request message. In FIG. 25, although step S2501 is shown as a single transmission, according to an embodiment, the first device (2510) may transmit multiple sets of reference signals using multiple patterns.

In step S2503, the second device (2520) measures uncertainty for the GP model and performs at least one channel task. Here, the channel task is at least one of tasks related to reference signals, e.g., channel estimation, CSI feedback generation, phase error estimation, or location estimation. Additionally, the second device (2520) may train the receiver GP model. By measuring uncertainty, the second device (2520) may determine which reference signal pattern is more necessary for subsequent training.

In step S2505, the second device (2520) reports information related to preferred active learning reference signals to the first device (2510). For example, the second device (2520) may transmit information representing at least one preferred active learning reference signal pattern among candidate reference signal patterns. The preferred active learning reference signal pattern may include at least one reference signal pattern having the highest acquisition function result value.

In step S2507, the first device (2510) transmits the preferred active learning reference signals to the second device (2520). The first device (2510) transmits reference signals according to the reference signal pattern requested by the second device (2520). If multiple reference signal patterns are reported in step S2505, the first device (2510) may select one reference signal pattern among the reported patterns based on a predefined rule, and may transmit reference signals based on the selected reference signal pattern. Here, the preferred active learning reference signals may be transmitted via pre-configured resources. Alternatively, the first device (2510) may first transmit resource information related to the preferred active learning reference signals, and then transmit the preferred active learning reference signals.

In step S2509, the second device (2520) searches for the next reference signal pattern to minimize the model uncertainty of the GP model and determines the related reference signal pattern. Specifically, the second device (2520) trains the receiver GP model using the active learning reference signals received in step S2507, and measures uncertainty. By measuring uncertainty, the second device (2520) may determine which reference signal pattern is more necessary for subsequent training.

In step S2511, the second device (2520) reports information related to preferred active learning reference signals to the first device (2510). For example, the second device (2520) may transmit information representing the preferred active learning reference signal pattern among candidate reference signal patterns. The preferred active learning reference signal pattern may include at least one reference signal pattern having the highest acquisition function result value.

In step S2513, the first device (2510) transmits the preferred active learning reference signals to the second device (2520). The first device (2510) transmits reference signals based on the reference signal pattern requested by the second device (2520). Here, the preferred active learning reference signals may be transmitted via pre-configured resources. Alternatively, the first device (2510) may first transmit resource information related to the preferred active learning reference signals and then transmit the preferred active learning reference signals.

As described with reference to FIG. 25, the first device (2510) sequentially transmits reference signals for each pattern included in a pre-defined set of active learning reference signal patterns. The second device (2520) evaluates uncertainty for the active learning reference signals of each pattern and transmits a measurement report for at least one preferred active learning reference signal pattern to the first device (2510). Based on an embodiment, the preference for active learning reference signal patterns may depend on the density or the amount of wireless resources. For example, a reference signal pattern occupying fewer wireless resources may be preferred. The first device (2510) transmits active learning reference signals corresponding to patterns that utilize as few wireless resources as possible based on measurement reports from the second device (2520). Based on this, the transmitter model and/or receiver model may be trained.

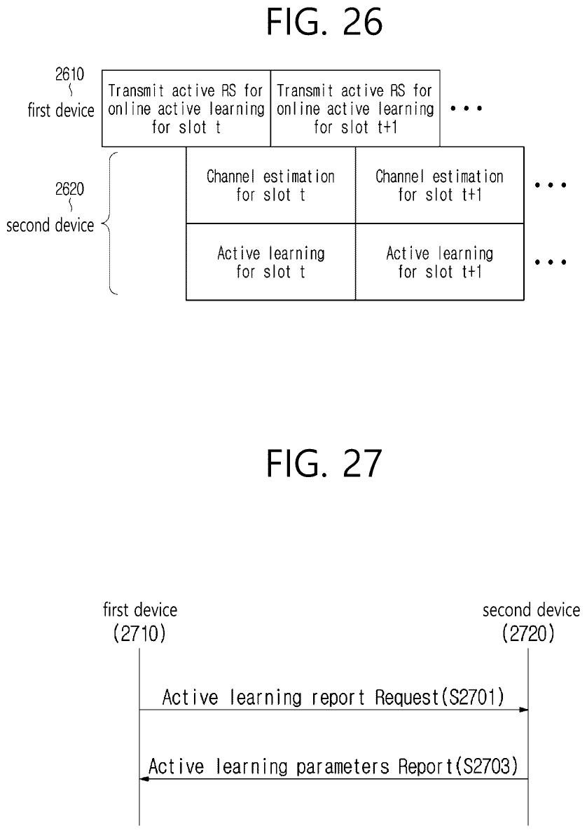

FIG. 26 shows an example of operational timing for active reference signal transmission and channel estimation, based on an embodiment of the present disclosure. Referring to FIG. 26, the first device (2610), serving as a transmitter, and the second device (2620), serving as a receiver, may operate in a pipeline manner as shown in FIG. 26 over time. The second device (2620) receives active learning reference signals, performs channel estimation, and then updates the model. At the same time, the second device (2620) performs measurements for uncertainty sampling. The second device (2620) requests at least one active reference signal pattern, using the least amount of wireless resources among the active learning reference signal sets, from the first device (2610). For example, the second device (2620) may request the preferred active learning reference signal pattern from the first device (2610). Here, the preferred active learning reference signal pattern may be determined as shown in [Equation 16] below.

$${x}^{*} = arg max {f}_{a c q} ( x ; ϕ ) , {D}_{x} ∋ x \qquad [ Equation 16 ]$$

In [Equation 16], x\hat{ }* refers to the preferred active learning reference signal pattern. f_acq(x,q) refers to the output of the acquisition function for x based on the model φ. D_x refers to a set of reference signal patterns. x refers to a reference signal pattern. Here, x may be a single or multiple reference signal pattern(s) composed of antenna, frequency, and time.

FIG. 27 shows an example procedure for reporting results of active learning, based on an embodiment of the present disclosure. FIG. 27 shows signaling for reporting results of active learning between a first device (2710) and a second device (2720).

Referring to FIG. 27, in step S2701, the first device (2710) transmits an active learning report request message to the second device (2720). For example, the first device (2710) requests information related to at least one of the receiver GP model and transmitter GP model determined by active learning from the second device (2720). As described with reference to FIG. 25, since training of the GP model is performed by the second device (2720), it is necessary to deliver information related to the GP model, e.g., model parameters, to the first device (2710).

In step S2703, the second device (2720) transmits an active learning parameters report message to the first device (2710). For example, the second device (2720) transmits information related to at least one of the receiver GP model and transmitter GP model. Accordingly, the first device (2710) may obtain a transmitter GP model corresponding to the trained receiver GP model.

As described with reference to FIG. 27, the second device (2720) may provide information related to results of active learning. Specifically, information elements or parameters included in the active learning parameters report message may include at least one of the items listed in [Table 4] below.

TABLE 4

| Information element | Description |
|---|---|
| Model parameters | Model parameter values of the |
| | kernel minimizing the loss |
| | function of the current model, |
| | and the loss function values |
| Channel context ID | Identifier related to the current |
| | channel regression task. |

According to the procedure as shown in FIG. 27, the first device (2710) may obtain the trained model f_acq(x,φ\hat{ }R). If the trained model is reported to the first device (2710), the first device (2710) may reflect f_acq(x,φ\hat{ }R) into the currently used transmitter model or precoding. In this case, the receiver model of the second device (2720) may be configured as an identity matrix. For example, in the downlink, this provides advantages of reducing the UE's training complexity and enabling the base station to completely obtain channel state information. For example, a procedure such as the one described above with reference to FIG. 27 is necessary to configure the receiver model as an identity matrix and to reflect the trained receiver model into the transmitter model. For example, the initial transmitter model may be an identity matrix or perform precoding optimized for a previous channel state, and training for the transmitter model may not be separately conducted. In this case, the training results of the receiver model may be reflected in the transmitter model based on the procedure described with reference to FIG. 27.

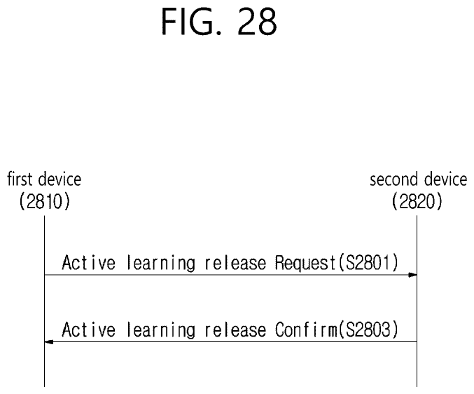

FIG. 28 shows an example procedure for terminating active learning, based on an embodiment of the present disclosure. FIG. 28 shows signaling for terminating active learning between a first device (2810) and a second device (2820).

Referring to FIG. 28, in step S2801, the first device (2810) transmits an active learning release request message to the second device (2820). For example, the first device (2810) indicates termination of active learning.

In step S2803, the second device (2820) transmits an active learning release confirm message to the first device (2810). For example, the second device (2820) indicates that it has received the instruction to terminate active learning.

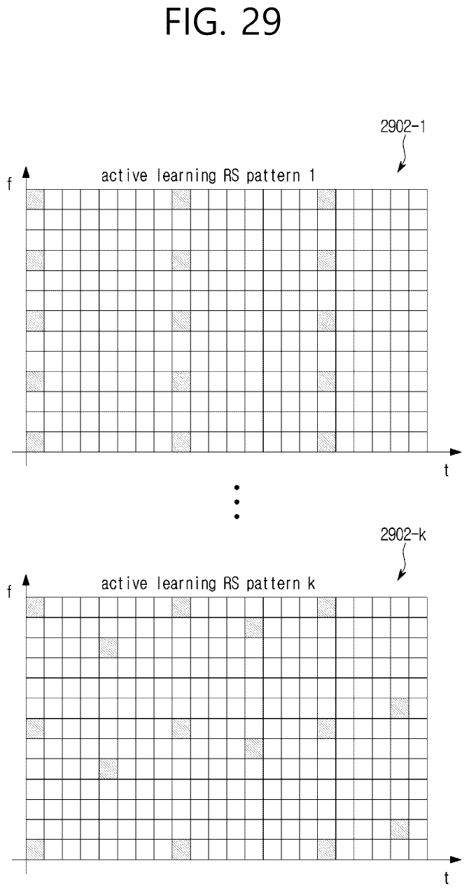

Based on the various embodiments described above, a GP model-based transmitter and receiver may be trained. The embodiments described above may be applied to a base station and a UE. In this case, a base station having a transmitter model may transmit downlink active learning reference signals to the UE's receiver. For example, a first active learning pattern may sequentially transmit a set of various patterns consisting of k antenna ports, as shown in FIG. 29. FIG. 29 shows examples of reference signal patterns for active learning, based on an embodiment of the present disclosure. Referring to FIG. 29, k reference signal patterns (2902-1 to 2902-k) may be defined. The reference signal patterns (2902-1 to 2902-k) differ from each other in at least one of positions of resources mapped by reference signals, the amount of resources, and resolutions along frequency or time axes. However, the definitions of patterns as shown in FIG. 29 are merely examples, and differences between patterns may be defined or expressed differently according to various embodiments.

For example, initial training necessary for active learning of a base station and a UE may be performed by using reference signal sets having patterns such as those in FIG. 29. Alternatively, the UE may receive parameters related to a prior model from the base station based on channel-dependent information. After completing prior training or obtaining parameters related to the prior model, the UE may evaluate uncertainty for each of the active learning reference signal patterns. The UE may select the pattern with the lowest density of reference signals or the pattern with the highest uncertainty, and inform the base station of the selected at least one pattern. Based on this, active learning may be performed. The density and uncertainty of the reference signal patterns have a trade-off relationship.

In the case of a stationary device, since the channel hardly changes, after initial transmission, active learning may proceed by either decreasing uncertainty or increasing the density.

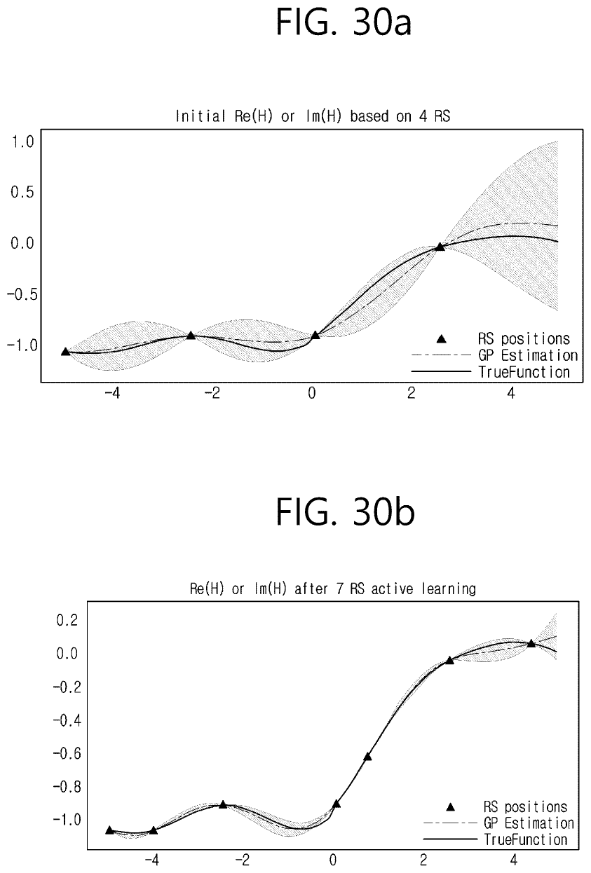

FIGS. 30a and 30b show examples of evaluation results of uncertainty for an GP model, based on an embodiment of the present disclosure. In FIGS. 30a and 30b, the horizontal axis represents values obtained by scaling a frequency axis consisting of 72 subcarriers to a range of −5 to 5, and the vertical axis represents the real or imaginary part of a channel estimation value. FIG. 30a shows a situation after initial reference signal transmission, representing evaluation results of uncertainty after initially transmitting reference signals on 4 of 72 subcarriers. The shaded region may be understood as representing the largest uncertainty evaluated among individual base estimation models.

FIG. 30b shows a situation after the second reference signal transmission, showing the results of requesting and receiving the pattern of x\hat{ }* selected to minimize uncertainty. Specifically, FIG. 30b shows evaluation results obtained after receiving reference signals having a pattern additionally including 3 reference signals. Referring to FIG. 30b, it is confirmed that uncertainty is reduced in most ranges, and that estimated channel values closely approximate actual channel values with small errors. Moreover, it is confirmed that reference signals are transmitted in a direction with higher density.

When the channel environment is static, adaptively applying reference signal patterns based on uncertainty may reduce the average amount of reference signal transmission compared to continuously transmitting fixed reference signal patterns for a specific period. When the channel environment changes rapidly, the base station may transmit reference signals using a high-density reference signal pattern, and the UE may gradually increase the number of reference signals according to the pattern. Through this, the UE may determine the density of reference signals suitable for the average uncertainty level of the current channel environment and request the related pattern from the base station at a longer interval. Because the channel environment changes rapidly, the optimal reference signal pattern may be maintained by adjusting the request period of the reference signal pattern and the uncertainty level. For example, the base station may apply a pattern including 7 reference signals at the first transmission and may then increase the number of reference signals to 4, 5, and 6. At this time, if the UE evaluates the average acceptable uncertainty level and determines that there is no operational issue using 4 reference signals, it may feed back the evaluation result to the base station, thereby performing communication with only 4 reference signals for an extended period. For example, if the evaluated uncertainty is smaller than the threshold, the UE may determine that there is no operational issue.

As described above, by fully utilizing the capability of the GP model and using only the necessary reference signals, the usage of reference signal resources may be reduced. The procedure suitably designed for Gaussian processes (GP) may effectively solve the channel task issues between the transmitter and receiver. In particular, through the proposed signaling procedure, the receiver's learned information may be conveyed to the transmitter, enabling incremental increases in reference signals. Furthermore, uncertainty may be easily modeled with Gaussian processes (GP), which is a Bayesian model. Through this, radio resources may be effectively utilized.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method for operating a user equipment (UE), the method comprising:
transmitting, to a base station, capability information;
receiving, from the base station, configuration information related to reference signals;
receiving the reference signals based on the configuration information; and
transmitting feedback information related to the reference signals,
wherein the configuration information includes information related to a receiver model for a reception operation of the UE and information related to at least one kernel function related to the receiver model.

2. The method of claim 1,
wherein the feedback information includes information related to at least one preferred reference signal pattern selected by the UE, and requests transmission of reference signals based on the at least one preferred reference signal pattern.

3. The method of claim 1,
wherein the receiver model includes a Gaussian process (GP) model,
wherein the capability information includes at least one of information representing at least one supported GP model, information representing at least one supported kernel function, and information representing at least one supported acquisition function.

4. The method of claim 1,
wherein the configuration information includes at least one of information related to patterns of the reference signals and information related to an acquisition function,
wherein the information related to the at least one kernel function includes a type of the at least one kernel function and at least one hyperparameter value of the at least one kernel function.

5. The method of claim 1, further comprising:
performing prediction on the reference signals using the receiver model for the reception operation;
determining an uncertainty metric for a result of the prediction; and
determining the at least one preferred reference signal pattern based on the uncertainty metric.

6. The method of claim 5, further comprising:
receiving reference signals based on the at least one preferred reference signal pattern; and
performing training for the receiver model, based on the reference signals based on the at least one preferred reference signal pattern.

7. The method of claim 5,
wherein the reference signal pattern indicates at least one of a number of reference signals belonging to a set, a density of the reference signals, frequency-axis intervals of the reference signals, time-axis intervals of the reference signals, resource element (RE) positions allocated to the reference signals, an RE to which one reference signal may be mapped, transmission power, sequence, covering code, a slot period in which the reference signals are transmitted, and attributes of resources on which the reference signals are transmitted.

8. The method of claim 1, further comprising:
performing active learning on the receiver model for the reception operation using the reference signals; and
transmitting a report for a result of the active learning,
wherein the report includes at least one of information related to parameters of the kernel function determined by the active learning and information related to a channel task.

9. The method of claim 8, further comprising:
receiving a request message requesting release of the active learning; and
transmitting an acknowledgment message representing confirmation of the release of the active learning.

10. A method for operating a base station, the method comprising:
receiving, from a user equipment (UE), capability information;
transmitting configuration information related to reference signals;
transmitting the reference signals based on the configuration information; and
receiving, from the UE, feedback information related to the reference signals,
wherein the configuration information includes information related to a receiver model for a reception operation of the UE and information related to at least one kernel function related to the receiver model.

11. The method of claim 10,
wherein the feedback information includes information related to at least one preferred reference signal pattern selected by the UE, and requests transmission of reference signals based on the at least one preferred reference signal pattern.

12. The method of claim 10,
wherein the receiver model includes a Gaussian process (GP) model,
wherein the capability information includes at least one of information representing at least one supported GP model, information representing at least one supported kernel function, and information representing at least one supported acquisition function.

13. The method of claim 10,
wherein the configuration information includes at least one of information related to patterns of the reference signals and information related to an acquisition function,
wherein the information related to the at least one kernel function includes a type of the at least one kernel function and at least one hyperparameter value of the at least one kernel function.

14. The method of claim 10, further comprising:
receiving a report related to a result of active learning performed at the UE for the receiver model using the reference signals; and
configuring a transmitter model for a transmission operation of the base station based on a result of the active learning,
wherein the report includes at least one of information related to model parameters determined by the active learning and information related to a channel task.

15. A user equipment (UE) in a wireless communication system, the UE comprising:
a transceiver; and
a processor connected to the transceiver,
wherein the processor is configured to perform operations comprising:
transmitting, to a base station, capability information;
receiving, from the base station, configuration information related to reference signals;
receiving the reference signals based on the configuration information; and
transmitting feedback information related to the reference signals,
wherein the configuration information includes information related to a receiver model for a reception operation of the UE and information related to at least one kernel function related to the receiver model.

19. The UE of claim 15,
wherein the feedback information includes information related to at least one preferred reference signal pattern selected by the UE, and requests transmission of reference signals based on the at least one preferred reference signal pattern.

20. The UE of claim 15,
wherein the receiver model includes a Gaussian process (GP) model,
wherein the capability information includes at least one of information representing at least one supported GP model, information representing at least one supported kernel function, and information representing at least one supported acquisition function.

21. The UE of claim 15,
wherein the configuration information includes at least one of information related to patterns of the reference signals and information related to an acquisition function,
wherein the information related to the at least one kernel function includes a type of the at least one kernel function and at least one hyperparameter value of the at least one kernel function.
